(19) United States
(12) Patent Application Publication
(10) Pub. No.: US 2015/0032297 A1
(43) Pub. Date: Jan. 29, 2015

(54) ELECTRONIC FLIGHT TEST CARD

(71) Applicant: MicroPilot Inc., Stony Mountain (CA)

(72) Inventors: Howard William LOEWEN, Winnipeg (CA); Tyler Desmond MELMOTH, Winnipeg (CA); Adam Jacob TOEWS, Winnipeg (CA)

(73) Assignee: MICROPILOT INC., Stony Mountain (CA)

(21) Appl. No.: 14/331,492

(22) Filed: Jul. 15, 2014

Related U.S. Application Data
(60) Provisional application No. 61/857,441, filed on Jul. 23, 2013.

(51) Int. Cl. B64F 5/00

(52) U.S. Cl. CPC B64F 5/0045
USPC 701/3

(57) ABSTRACT

An electronic flight test card for testing a UAV (Unmanned Aerial Vehicle) design is provided. The flight test card comprises: a module comprising a list of tests to be performed, each test linked to a requirement for a system or subsystem of the UAV; an interface for communicating with the UAV; a storage medium with a data log for storing the test results captured by the interface; a display module for displaying test items; and an output for exporting the data log to a configuration system.

This application claims the benefit of U.S. Provisional Patent Application No. 61/857,441 filed Jul. 23, 2013.

### TECHNICAL FIELD

The present disclosure relates to an electronic flight test card and a method of creating an electronic flight test card.

### BACKGROUND

Unmanned aerial vehicle (UAV) manufacturers and other complex system manufacturers, depend on design processes, whether they are unstructured and ad-hoc or highly structured and well considered. As the UAVs produced become more sophisticated, ad-hoc design processes become insufficient. Presently, more UAV manufacturers than ever have come to realize structured design processes are essential if they intend to develop reliable products.

Furthermore, as regulations develop, manufacturers learn regulating bodies do not tolerate unstructured design methodologies. Moreover, consumers are becoming more sophisticated. UAV end users want evidence verifying their systems are safe. This request cannot be answered by rationalizing away risk. Instead, UAV manufacturers need a robust, structured design process delivering proof that all safety regulations are met.

Unmanned aerial vehicle (UAV) manufacturers rely on a decision making process to incorporate basic sciences, mathematics, and engineering systems into a design plan. Design management uses this formalized design process to convert resources into a final product that meets the needs of the manufacturer and its customers. Without a formal design process, projects can fail and products can nosedive.

A requirements-based design process is the most widely used design process for bringing UAVs into production. While requirements based design processes might not be the most suitable for designing a desk lamp; however, this thorough methodology is well suited to addressing the concerns UAV manufacturers face when designing their products.

Requirements describe the functionality of a system, while bridging gaps between non-technical design team members (e.g. marketing) and those who implement the design. Clear and accurate communication is essential when designing a highly technical system. Moreover, a requirements-based configuration system does not tolerate slip-ups because all design decisions are well documented and all implementation details are derived directly from the systems intended use. UAVs are airborne products; therefore, manufacturers designing UAVs must use a design process that does not allow a single detail to fall through the cracks. As with any airborne product, even the smallest design error can lead to serious consequences. A seemingly minor error can contribute to the total loss of a UAV and its payload. In extreme cases, minor errors can even cause injury or even loss of life.

To best convert a marketing concept into a real life system, wish lists dreamed up by high-level management (or high-level requirements) must be broken down into more design-specific instructions. Design teams depend on these decomposed instructions (or low-level requirements) to develop the UAV.

### SUMMARY

In one aspect, there is provided a computer-implemented method of designing failure modes of a product, the method comprising: decomposing systems of the product into subsystems based on information stored in a database; receiving through a user interface a failure mode for at least one of the subsystems; adding at least one requirement to the subsystem to address the failure mode; implementing the at least one requirement; validating the implementation at a subsystem level, a system level and a product level; and outputting results of the validating to a configuration system.

In another aspect, there is provided an electronic flight test card for testing a UAV design, the flight test card comprising: a module comprising a list of tests to be performed, each test linked to a requirement; an interface for capturing test results from the UAV; a storage medium with a data log for storing the test results captured by the interface; a display module for displaying test items; and an output for exporting the data log to a configuration system.

In another aspect, there is provided a computer-implemented method of validating UAV design requirements, the method comprising: creating an electronic flight test card as described herein based on requirements of systems and subsystems of the UAV; assigning at least one flight test and at least one user to the electronic flight test card; downloading the electronic test card to a mobile ground control station; recording test data in the data log while conducting the at least one flight test; and uploading a data log from the electronic test card to a configuration system after the at least one flight test is complete.

In an embodiment, the method further comprises analysing the data log to determine if further changes to the design requirements are required; and outputting results of the analysing to an output of the configuration system.

In some embodiments, the method further comprises recording a start time for each test. In some embodiments, the method of further comprises recording an end time for each test. In some embodiments the method further comprises using the start time and the end time to link a portion of the data log to one or more of the requirements.

### BRIEF DESCRIPTION OF THE DRAWINGS

FIG. 1 is a diagram of a life cycle of a product accordance with one example embodiment of the present disclosure;

FIG. 2 is a diagram of an example requirement hierarchy according to one example embodiment of the present disclosure;

FIG. 3 is a diagram of a Failure Mode Risk Matrix according to one example embodiment of the present disclosure;

FIG. 4 is a diagram of Failure Mode process according to one example embodiment of the present disclosure;

FIG. 5 is a diagram of a configuration system according to one example embodiment of the present disclosure;

FIG. 6 is a diagram of a management review process according to one example embodiment of the present disclosure;

FIG. 7 is a screen shot of an electronic flight test card according to one example embodiment of the present disclosure.

FIG. 8 is a screen shot of an electronic flight test card according to one example embodiment of the present disclosure; and

FIG. 9 is a screen shot of an electronic flight test card according to one example embodiment of the present disclosure.

### DETAILED DESCRIPTION

To the accomplishment of the foregoing and related ends, certain illustrative aspects are described herein in connection with the following description and the annexed drawings. These aspects are indicative of the various ways in which the principles disclosed herein can be practiced. Other advantages and novel features will become apparent from the following detailed description when considered in conjunction with the drawings.

UAV Life Cycle

A typical life cycle of a technical product covers the product from conception to the end of its useful life. This includes building requirements, performing failure analysis, satisfying requirements, validating the final system to ensure it meets the user needs, and finally production and technical support. The configure system and method described herein aid system designer teams through this process. The systems and methods are described with reference to UAV design but are equally applicable to any technical product design that would benefit from requirements based design.

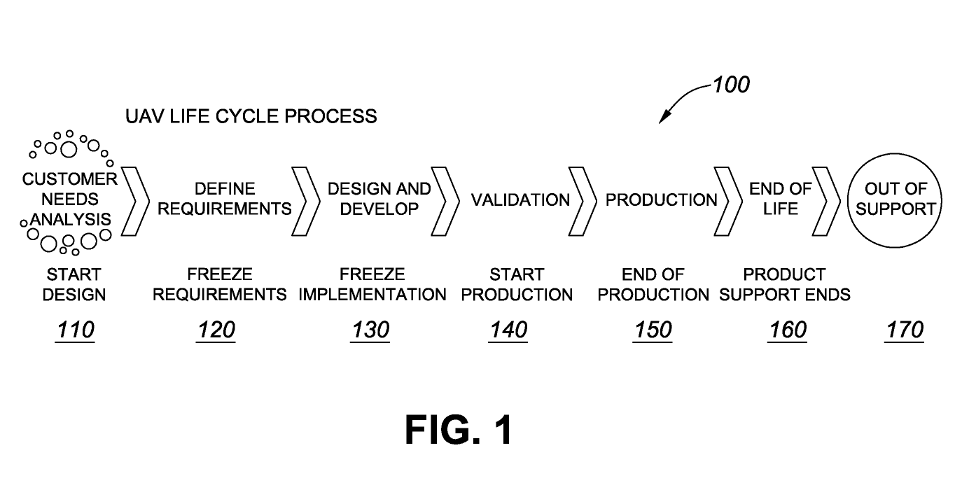

Referring to FIG. 1, a UAV Life Cycle Process 100 will be described. The process starts with customer needs analysis 110 which kicks off the design. From the needs, requirements are defined 120. Once the requirements are frozen, the process proceeds to the design and development stage 130. Once the implementation of the design is decided or frozen, the process moves onto the validation stage 140. After validation, production 150 starts. At the end of production, the end of life stage 160 begins and product support ends. Then, the product goes into the final out of support stage 170.

Bringing a UAV through its entire life cycle is a complex process. The number of choices and details can quickly overwhelm even the most organized design management. However, a structured lifecycle management process and system for implementing the process, as will be described herein, allows design management to assemble and track a diverse set of operational requirements. In the end, executives find peace of mind knowing high-level requirements will be implemented correctly and provide the required functionality.

Phase 1: Developing Requirements

In requirements based development, the gap between non-technical marketing management and those who implement the design is bridged. The configuration system described herein enables teams to coordinate their efforts. Quality control verifies that team efforts match what the technical product, such as a UAV, should accomplish.

Requirements describe the functionality of the system and guarantee the system meets manufacturing limitations, customer needs, safety regulations, and other government requirements. A requirement usually consists of a single sentence that describes a certain function that a system must provide. For example, a requirement might say: “The UAV will be electrically powered.”

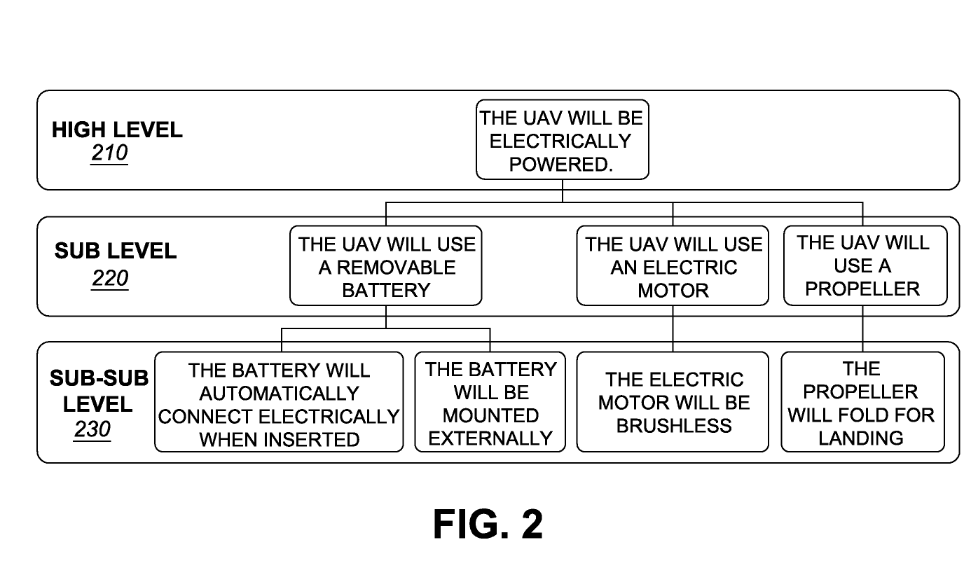

Referring to FIG. 2, the hierarchical nature of requirements will be described. Higher-level requirements 210 decompose into lower-level or sub level requirements 220. “The UAV will be electrically powered” requirement mentioned above is a higher-level requirement and would usually be written by marketing management. Once marketing management signs off on the higher-level requirements, design management would usually break them down into lower-level requirements. In the example of FIG. 2, the requirement is decomposed into three sub-requirements: “The UAV will use a removable battery”; “The UAV will use an electric motor”; and “The UAV will use a propeller.” Lower-level requirements are usually specified by engineering and product development.

Then, these lower-level requirements are broken down further into sub-sub requirements 230, usually by system designer teams. “The UAV will use a removable battery” might break down into: “The battery will automatically connect electrically when inserted”; and “The Battery will be mounted externally.” “The UAV will use an electric motor” might break down into “The electric motor will be brushless” and “The UAV will use a propeller” might break down into “The propeller will fold for landing”.

In some cases, requirements are related to other requirements in ways that are not included in the hierarchy. The UAV configuration system described herein allows system designer teams to link any requirement with any other requirement to capture these relationships. Then, when design management needs to make changes, all linked requirements can be easily analyzed to determine if the change affects them.

Phase 2: Failure Analysis

Often, requirements dictate what systems are incorporated into a UAV. For example, a typical UAV will have a propulsion system, a control system, and a communication system. These systems can fail and it is important to the design of a UAV that the system designer teams analyze the various failure modes of each system.

Since the most important requirements in a UAV system are those related to failure modes, the configuration system's failure analysis module links subsystem failure modes to requirements, ensuring all subsystem failures are handled. Additionally, when design management links failure modes to requirements, they can also assign a mitigation factor that reduces a failure's severity, likelihood or both.

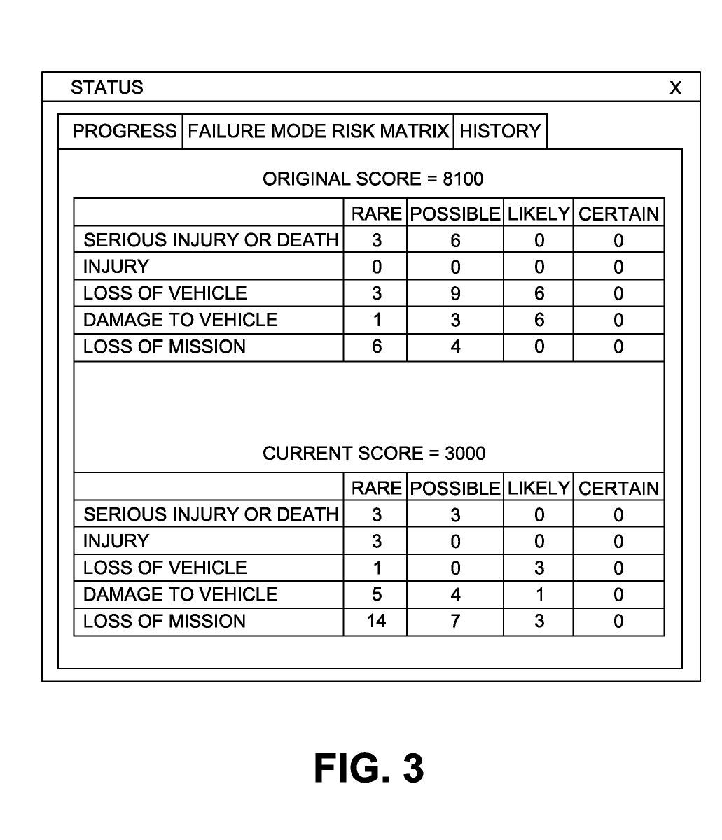

Furthermore, the configuration system allows users to assign a severity and likelihood to each failure. Design management can then assign a point score to each of the severity levels, as well as one or more failure likelihood categories. When this is complete, the UAV configuration system builds a matrix, identifying high-priority failures so that the system designer teams can focus on the most severe and most likely failures. An example of a Failure Mode Risk Matrix according to one embodiment of the present disclosure is shown in FIG. 3.

When systems are introduced into the UAV, operations can fail. For instance, considering the example above, the propeller might become damaged during landing. Before developers freeze requirements and move the project into Implementation phase, the system designer teams can perform a failure analysis by decomposing each system into its sub-systems (or sub-sub-system) and determining the possible failure modes of each of these sub-systems.

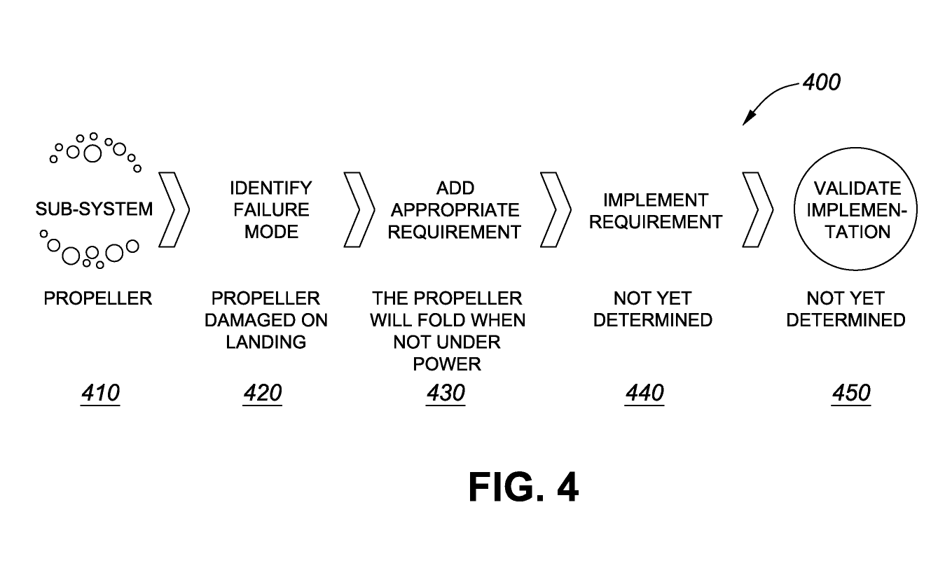

Referring to FIG. 4, a Failure Mitigation Process 400 according to the present disclosure will now be described. To better achieve collating all system failure modes into one organized structure, system designer teams decompose systems into sub-systems 410, such as the propeller. This can then be input through a user interface into a requirements based design system. The next step 420 is to identify a failure mode. For example, “propeller damaged on landing” could be a failure mode. The failure modes can be entered using a user interface and then, appropriate requirements to address the failure mode are added 430 to the requirements hierarchy. For example, the requirement that “the propeller will fold when not under power” could be added. Then, the requirement is implemented 440 and the implementation is validated 450. The implementation and validation can be accomplished by simulation or flight testing. The nature of the validation will depend on the nature of the requirement. Some requirements might not be critical and so it might not be worth testing them in flight. For other requirements, preliminary testing on a simulator is performed followed by some flight testing.

Consider the previous example with the high-level requirement “The UAV will be electrically powered,” and sub-level requirement “The UAV will use a propeller.” To resolve the landing issue, design management might add the sub-sub requirement: “The propeller will fold when not under power.” After analysis, configuration system guides design management to resolve or mitigate problems by adding new requirements. The configuration system allows system designer teams to list failure modes for each sub-system and then introduce requirements to mitigate each of these failures.

Again, in a requirements based design process, the first step to mitigating failures is to introduce new requirements. As another example, if failure modes can be mitigated by either pre-flight checks or a maintenance schedule, developers can create a requirement that specifies that the operator manual include a pre-flight checklist and a maintenance schedule. The configuration system described herein documents, tracks, and analyzes all steps of this process.

Failure modes can be addressed in a number of ways such as but not limited to writing some code, modifying some system options, changing statements in a script file on the autopilot.

Phase 3: Implementation

Once a full set of requirements is assembled, design management freezes requirements and the project enters the Implementation phase. At this stage, system designer teams focus on satisfying requirements. For a UAV, this typically involves designing the airframe, integrating various onboard systems, writing code, and developing manuals. It may also involve configuring option settings within an autopilot program and setting configuration information.

By now, leaf requirements are sufficiently specific that design management knows exactly how to proceed. Requirements can be satisfied via: Autopilot options; Ground control station options; UAV design; Documentation (such as manuals); Maintenance schedule; Custom software; and Installed systems (such as a transponder). Of course, other means of implementing requirements are possible and the preceding are examples only.

After marketing management signs off on the high level requirements, design management creates lower level requirements. For example, a high-level requirement “The UAV system will have an operator's manual,” might be broken down into lower level requirements: “The operator's manual will include a daily inspection,” and “The operator's manual will include a maintenance schedule.” System designer teams might further break down into a first lower level requirement, “The operator's manual will include a daily inspection,” into: “Daily checklist” and “Maintenance schedule.” After the user manual is written, design management indicates within the configuration system that the lowest level requirements for the manual are satisfied. The configuration system allows design management to be specific about implementation by supporting users to include such details in the manual as each low-level requirement is satisfied.

Sometimes developers satisfy requirements in multiple ways. Safety requirements, for example, might need appropriate settings within the UAV's autopilot, applicable maintenance, and some operator training. The configuration system allows requirements to be satisfied in more than one way. It also tracks which requirements have been fulfilled and how they were fulfilled. As a result, design management can easily comprehend how many requirements remain, and they can access progress details.

Phase 4: Validation

Once all requirements are satisfied, with the support of the configuration system, design management freezes implementation, and the project enters the Validation phase. Since UAVs fly in the air, as opposed to sit on someone's desk, special care must be taken during testing. Moreover, due to a UAV's autonomous operation, special care must also be taken to ensure the system does not react in a dangerous manner. Validation is also performed for requirements relating to other aspects of the product, such as the user manual. In this case, quality control might perform user testing with the manual and submit a report within the configuration system confirming that the wording in the manual is acceptable. This is considered validation.

Moreover, first flights are not without risk. To minimize hazards, the configuration system allows team members to flag individual requirements that must be validated before the first flight. Furthermore, the configuration system systematically communicates to the flight test team how each requirement should be validated, based on the system designers' inputs.

When design management sees their UAVs through validation, they are compiling evidence that all requirements are implemented correctly. Simply trusting a team member's opinion as to whether a requirement is fulfilled can lead to failure down the line. Quality confirmation includes, for example: Written arguments; Ground test data; Simulation data; and Flight test data.

The configuration system allows flight test team members to submit proof that a requirement has been validated.

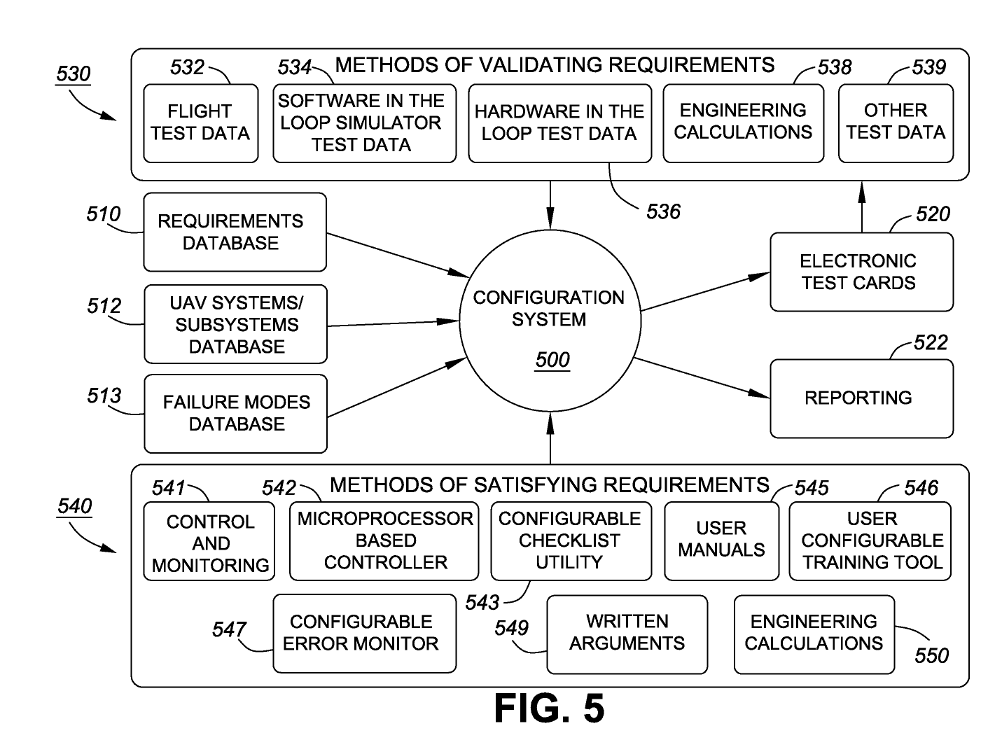

Referring to FIG. 5, an example embodiment of a configuration system 500 will now be described. The configuration system 500 accepts input from a requirements database 510, a UAV Systems/Subsystems database 512, a Failure Mode database 513, various methods of validating requirements 530 and various methods of satisfying requirements 540. In the example embodiment shown in FIG. 5, the methods of validating requirements include Flight Test Data 532, Software in Loop Simulator Test Data 534, Hardware in the Loop Test Data 536, Engineering Calculations 538 and Other Test Data 539. Other methods of validating are possible. In the example embodiment shown in FIG. 5, the methods of satisfying requirements 540 include control and monitoring 541, a microprocessor based controller 542, a Configurable Checklist Utility 543, User Manuals 545, a User Configurable Training Tool 546, a configurable error monitor 547, Written Arguments 549, and Engineering Calculations 550. The Configuration system 500 outputs to a reporting module 522 and to electronic flight test cards 520. The electronic flight test cards 520 provide data to the methods of validating requirements 530.

The configuration system 500 accepts input from the requirements database 510, the UAV systems/subsystems database 512, and the Failure Mode Database 513. The UAV Systems/Subsystems database 512 is a list of the pieces of hardware that make up the UAV. It contains systems (for example, propulsion) that are broken down into sub-systems (for example, battery, speed controller, electric motor, and propeller). A Failure Mode database 513 is built up by analyzing the possible failure modes of each system and subsystem. The failure modes are linked to the systems and sub systems from which they are derived.

There are various methods of satisfying requirements 540. The methods of satisfying requirements are dependent upon the system being used. Most of the methods shown in FIG. 5 are derived from Micropilot™ products. There may be others for different systems or different products. However, the collection shown illustrates example components that might form a part of another system.

The Control and monitoring software 541 in this embodiment includes settings that control the operation of a ground station. There can be hundreds of settings for the ground station.

The microprocessor based controller 542 in this embodiment includes settings for autopilot software. There can be many hundreds of such settings, which determine how the autopilot operates. The settings depend heavily on the requirements.

The Configurable Checklist Utility 543 is another method of satisfying requirements. Checklists ensure safe and correct operation. Some requirements will be best satisfied by one or more steps on a checklist.

Some requirements (especially those that mitigate failures) might have a training component. In this embodiment, the User Configurable Training Tool 546 or scenario based training software is used in a scenario based training program. The software allows you to build a scenario and incorporate it into a training plan.

The configurable error monitor 547 automatically watches for anomalous conditions and flags errors to the operator if they occur.

Written Arguments 549 is a module where a user can provide a description of why a requirement is satisfied. This feature can be used for requirements that do not fit nicely into any of the systems or subsystems.

Engineering Calculations 550 can also be used to satisfy requirements. You can also show that a requirement is validated by calculation. For example, you might have a requirement for a certain top speed. To show that you have satisfied that requirement you can have a calculation that predicts the top speed.

The configuration system 500 outputs to a reporting module 522 and electronic flight test cards 520. Reports can be used: to communicate requirements to individuals who do not have access to the software and or database; or to provide a comprehensive list of requirements that cannot be displayed due to the limitations of computer screens. The electronic flight test cards allow the grouping together of a number of tests to perform in a single flight. Furthermore, they allow a user to record the results of the tests into a data log and then insert the results back into the validation data database.

There are various methods of validating requirements 530. In some embodiments, validation occurs after satisfying the requirements. In some cases, you can show that a requirement is validated by calculation. For example you might have a requirement for a certain top speed. To show that you have satisfied that requirement you can have a calculation that predicts the top speed. Considering the previous example regarding “The UAV will be electrically powered,” with the sub requirement “The UAV will use a propeller,” and the sub-sub requirement “The propeller will fold when not under power,” its method of validation might be the written argument: “Over the one-hundred-flight-test period, no propellers were damaged in landing.”

Flight test data 532 can also be used for validation. In some embodiments, the flight test data is obtained from an electronic flight test card 520.

Electronic Flight Test Cards 520

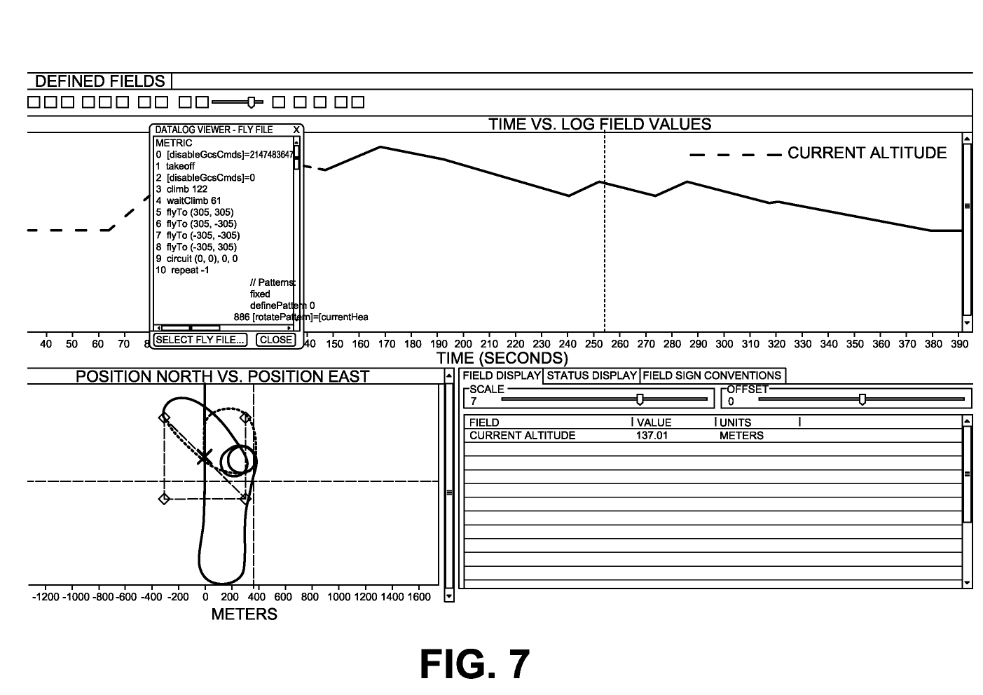

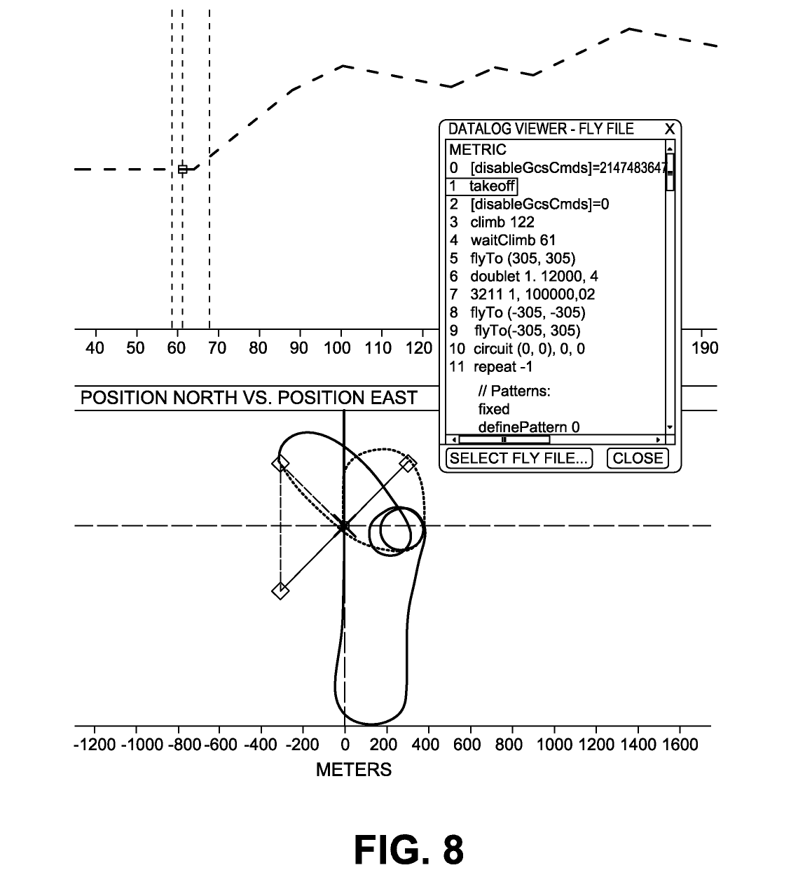

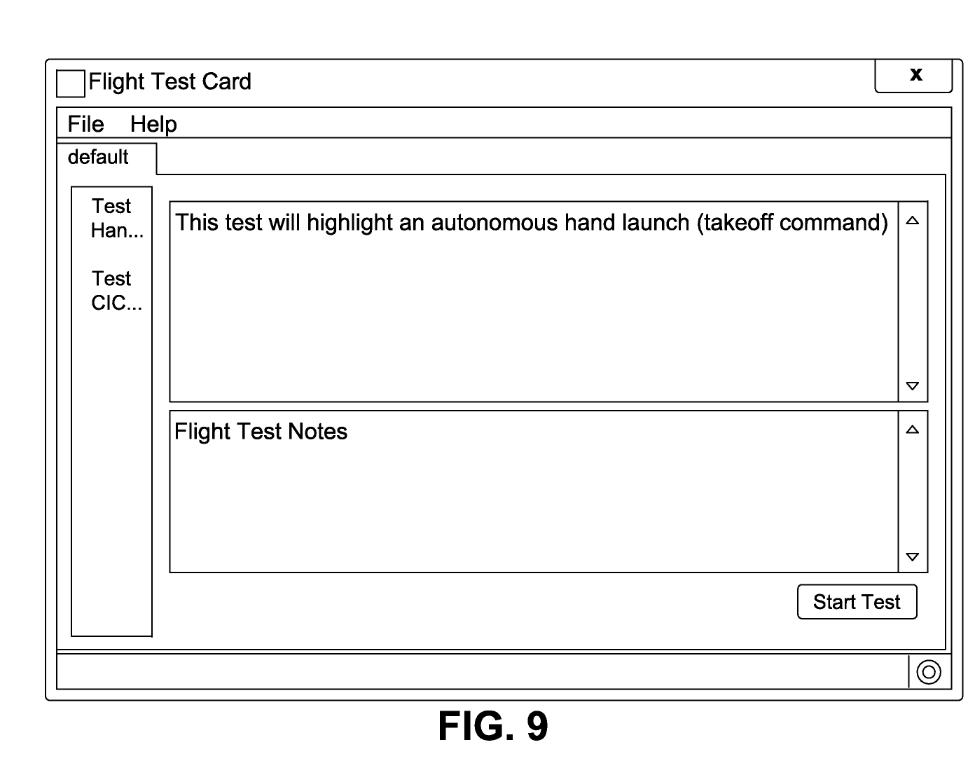

Since flight-testing is expensive and time consuming, the configuration system 500 can coordinate the validation of a variety of requirements during a single flight. The configuration system generates electronic flight test cards 520 based on how design management groups requirements. The electronic flight test card includes, for example: Descriptions for each test to perform during a single flight test or flight test session; Indicators for severity; and Scheduled date. FIGS. 7 and 8 show screen shots of data logs showing results of example electronic flight test cards 520. FIG. 7 shows a data log showing results of a flight test card for a landing and FIG. 8 shows a data log showing results of a flight test card for a take-off. FIG. 9 is a screen shot of an electronic flight test card for testing an autonomous hand launch.

The test card is downloaded onto the tester's ground control station and then presented to the tester at the time of the flight test. The electronic test card allows operators to record comments for each test and indicates if each section of the test card has been satisfied. Next, this data is fed into a data log, which is captured at the end of the flight. Flight test cards can be fully independent of the configuration system's 500 database, thus allowing flight testing to be performed in remote areas without access to a central database.

The configuration system 500 automatically enters appropriate requirements as satisfied and links them to validation data that can be used for the flight test card. At the end of the flight testing, data logs are loaded into the configuration system and the appropriate requirements are marked as validated.

In use, requirements that need flight testing are identified as such when they are created. Then, requirements that can be tested as a group in a single flight test are grouped together. The configuration system 500 creates one or more electronic test card to cover all of these requirements. Each flight requires only one card. Each test within a test card consists of a test description and sufficient information to identify the requirement from which the test originated. During a flight, the operator will indicate when each test within the test card starts and when it ends. During the flight, the operator will indicate whether or not each test passed and can include comments about each test. During the flight, the electronic flight test card software will communicate with the autopilot and indicate which tests are being performed and which tests passed or failed. The autopilot will incorporate this test identification information as well as the pass fail information into its onboard data log. The incorporation of the test identification information into the data log and the indication of which tests passed or failed can also be done on the ground. The electronic test card software can read a data log location when each test starts and the pass fail indicator. This information can be combined after the flight with the data log and submitted to a database. After the flight, the operator will download the data log. In some embodiments, the data log is first downloaded to an intermediary file at the test location and then transferred to a database later. In other embodiments, the data log is downloaded directly to a database. Once the data log has been downloaded from the autopilot, it will be submitted into the configuration system 500 database. Requirements whose tests have passed will be recorded as having been validated and the data log will be linked to those requirements as proof that they have been validated.

The data log provides “proof” that the test succeeded. This is useful when to certifying products that will be audited. In other words, the data log can be used to show that the test really took place and that it really passed.

Although, it is preferable to validate every requirement with flight testing, this is not always possible. In these cases, design management needs to determine which requirements represent high risk and require flight testing. Low-risk requirements can be left for simulation testing.

Simulation Tools 534, 536

Simulation tools can be used by UAV developers. For example, during the first level of validation, software 534 or hardware 536 loop simulators can be used to approximate a UAV's flight. Non-limiting examples of simulation tools that can be used include MicroPilot's SWIL, quasi-HWIL and HWILmp.

A software in the loop simulation (SWIL) is software that normally runs on a microcontroller and is recompiled and linked to a simulator so that it can run on a faster computer. In an embodiment, autopilot software runs on a windows-based computer and links a six degree of freedom flight simulator to the software. This allows a variety of tests to be performed on the software. It is much cheaper and much faster than flight testing.

The second type of simulator is the hardware in the loop simulator (HWIL). In a hardware in the loop simulator, the microcontroller is connected to a simulator running on a separate computer (usually windows-based). The microcontroller's sensor inputs and control outputs are bypassed. Sensor inputs are read from the simulator running on a separate computer and control outputs are sent to the simulator running on a separate computer.

In an embodiment, a six degree of freedom simulator is run on a windows-based PC that sends sensor information to an autopilot. The control outputs of the autopilot are read by the simulator, which simulates the aircraft and generates further sensor outputs for the autopilot.

Phase 5: Production

Once all requirements and implementations are validated, the project enters the Production phase. To ensure systems developed by multiple teams experience smooth production, the configuration system offers tools for dividing work among team members. Due to the complexity of bringing a UAV into production, design management often loses track of which members contributed and what they added. When this happens, an error found months or years later can be difficult to trace back to its original cause. Moreover, appropriate remedial action is hard to carry out without accountability data. An embodiment of the configuration system 500 tracks who performs which task to safeguard that everyone is accountable for his or her work.

Traceability

Traceability is fundamental to quality control. Embodiments of the configuration system 500 track all user actions. In an embodiment, user IDs are determined from the Windows login. Any time someone creates a requirement, changes a requirement, satisfies a requirement or validates a requirement, the changes made are identified by their login ID. The configuration system's database stores change history for each system requirement. Traceability is integral to accountability and when system designers know they are responsible for their actions, they tend to work more carefully.

Making Changes During Implementation and Production

Despite system designer teams' efforts, requirements need updating after they are frozen. In some cases, design management implements systems before requirements are complete, due to time constraints. Unavoidably parts will go out of production, leading system design teams to alter components. Moreover, marketing might present a new capability they need, which will also require design management to change requirements. The configuration system continues to support development by coordinating corrections at any stage. And most commonly, flight test teams will turn up errors in requirements, missed failure modes, and errors in implementation. These events also call for requirement revisions, implementation updates, and additional validation.

In addition, these requirements have complex dependencies and interactions that are easily lost or forgotten. Fortunately, the configuration system tracks these dependencies so when modifications are required long after the design has entered production (or maybe even after it has ceases production) design management can examine these interactions to determine how the change affects the system as a whole.

With the configuration system, design management can ensure appropriate changes are carried out on all levels. Due to the interrelated nature of requirements, system designer teams run the risk of introducing conflicting requirements or missing new failure modes introduced by the design change. Furthermore, changing requirements and implementations outside of the design process and in the midst of testing might invalidate certain test data. With the configuration system, design management can capture linkages between requirements. This feature allows design management to decide which portions of the system design need to be inspected and re-tested.

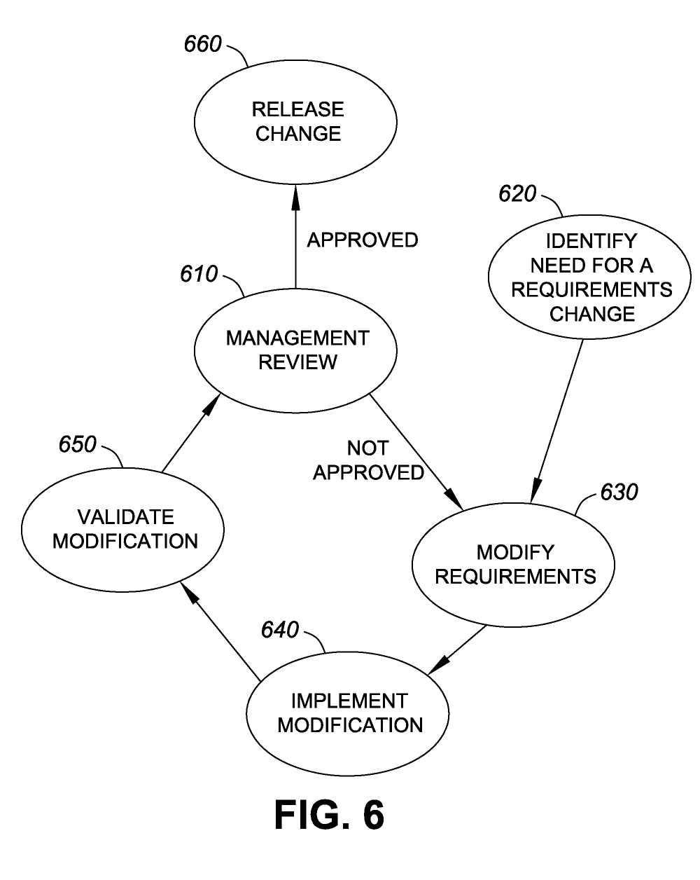

Referring to FIG. 6, a Requirements Change Process will now be described. In the event of risky changes made outside the normal project flow, design management can configure the configuration system to force a manager's review 610 of all requirements, implementations, or validations that are done out of order. In this event, designers can add more specifications, such as more rigorous testing. Then, a need for a requirements change is identified 620 and the process proceeds to modifying the requirements 630. Then, the modification is implemented 640 and validated 650 before proceeding to a management review 610. If it is approved after the management review, the change is released 660. If the change is not approved, the process repeats from modifying the requirements 630 until the change is approved and released 660.

When implementing change, the configuration (as it relates to the requirements) is checked to verify it is the configuration in use.

Reporting Tools

Communication is essential to successful requirements management. The configuration system 500 generates information that design management, flight test teams, and regulatory authorities need to bring a UAV through its life cycle. The configuration system's project dashboard, in an embodiment, provides a project overview, complete with progress and percent-complete indicators. The dashboard also displays unsatisfied requirements and un-validated requirements.

Furthermore, the failure matrix allows design management to see at a glance the progress in mitigating risk. The failure matrix is built before and after reduction so developers can monitor the progress of mitigating potential failures. This matrix also gives charts of failure risk scores as well as an indication of how much risk has been mitigated. This also helps design management recognize which failure modes comprise each category.

Streamline Requirements to Other UAVs

The configuration system 500 allows system designer teams to share requirements and sub-systems among various UAVs. For example, companies that manufacture several UAVs using the same transponder, can share transponder requirements with all UAVs incorporating this transponder.

In this way, developers can simplify new UAV designs by taking a proven set of requirements along with their satisfaction and validation data. They can add new requirements to accommodate new functionality. Of course, this is not without risk. However, if done carefully, this approach can significantly simplify a new design. Although, low-risk requirements do not require re-testing, high-risk requirements should be identified and validated separately.

In an example embodiment, the configuration system 500 fully integrates with other products, so that design management can automatically fulfill requirements by setting appropriate options and autopilot settings. In addition, the system integrator can submit these settings or options to the configuration system, thus indicating which requirement is satisfied.

Approaching End of Life

Often the operational life of aviation products surpasses their production. When UAVs approach the end of their life cycles, UAV manufacturers continue to manage requirements and provide support. For instance, when spares go out of production new components are then sourced. Manufacturers also upgrade existing vehicles.

Bringing a UAV to market is a complex task. The configuration system follows systems through all stages of development, including requirements building, failure analysis, implementation, validation, and finally production and technical support. Since this process requires a high degree of planning and coordination among a variety of individuals, the configuration system 500 provides a valuable means to coordinate the activities of all team members with traceability.

The configuration system 500 ensures subsystem failures are handled and offers the flexibility developers need to make changes during any stage of development. The configuration system facilitates successful testing by generating electronic flight test cards. And design management can depend on the configuration system's progress reports for requirement satisfaction, requirement validation, and mitigating risk. All these features support the configuration system customers in building systems that operate in the manner customers intended.

The implementation of a specific embodiment of the configuration system for use with UAV configuration will now be discussed.

First Time Setup: The first time the configuration system 500 is run, a database is generated to store information. An existing database can be used.

UAVs and Subsystems: A UAV contains many systems and subsystems. One example is the right wing. The right wing consists of aileron. Within the aileron, a servo is typically installed to control the aileron. With this description, the following tree can be formed within the configuration system 500:
Right Wing (subsystem of the UAV
   Aileron (subsystem of the right wing)
      Servo (subsystem of the aileron)

In some embodiments, there is a module to add a new UAV. New systems can be added using this module. Within this module, there is a module for adding new subsystems. The user interface for each of these modules can be a windows-based drop down menu in which the name, description and part information fields can be filled in. In some embodiments, details from an existing system or subsystem can be copied or cloned into a new system or subsystem. All changes to a cloned subsystem or its child subsystems are applied to all instances of the subsystem.

Failure Modes: Failure modes are considered problems that might affect subsystems. For example, a servo might experience problems that cause technicians to service the servo. Specifically, the gear teeth might break down due to deterioration. When this happens, the gear needs to be re-lubricated. Another example, electrical connectors might be lost, which connect the autopilot to servo. These problems are called “failure modes.” In an embodiment, example failure modes are: Deteriorated gear teeth; and Loss of electrical connection between autopilot and servo.

In an embodiment, each failure mode is assigned a Severity Level and a Probability Factor from the selections below:
Severity Levels: Inconvenient, Mission Failure, Reduced Safety, Increased Operator Workload, Critical
Probability Factors: Rare, Possible, Likely, Certain

For example, the gear teeth failure may be considered to have a severity of “critical” and a probability of “likely” or “certain.” The loss of electrical connection failure might have a severity of “reduced safety” and a probability of “rare” or “possible.”

Requirements: A requirement is often an area of work that needs to be addressed. For example, scheduled maintenance or a task to verify that operational requirements are met. Requirements are typically ordered in a tree-like, hierarchical structure with sub-requirements. The following are two examples of building requirements:

### Example 1

A failure mode of deteriorated servo gear teeth needs to be anticipated. The requirement for this could be “Have the servo serviced every ten flights.” Since this requirement is specifically for deteriorated gear teeth, the requirement can be associated with the failure mode.

### Example 2

A UAV used primarily for surveillance should have a very long flight time. A customer requirement for the UAV might be to have a flight time of two days; therefore, the requirement could be “Two days of flight time.”

Requirements are created and can then be joined to one or more UAVs. New requirements can be created using a create new requirement module. A unique name should be used for each requirement and fields, such as type, importance, validated by, flight test, and expires can be filled in. The following table show examples of options for requirement:

| | | |
|---|---|---|
| Type of Field | Safety | Requirements that address safety concerns (e.g., replacing or |
| | | servicing items after a period of service) |
| | Operational | Requirements regarding operational requirements (e.g., |
| | | minimum flight times) |
| | Prevent Operator Error | Requirements that help prevent operator errors (e.g., checklists |
| | | to ensure pre-flight tests are performed correctly) |
| | Payload | Requirements that address payload specifications (e.g., |
| | | minimum payload size and/or weight} |
| | Mission | Requirements regarding mission specifics (e.g., minimum |
| | | spatial resolution of images taken by an onboard camera) |
| Importance | Low | Requirements of lowest importance |
| | Medium (default) | Requirements of medium importance |
| | High | Requirements of highest importance(mission critical) |
| Validated By | Flight Test | Requirements must be validated with the following validation |
| | | types: |
| | | Flight test data log |
| | | Standard telemetry log |
| | | User telemetry log |
| | | Vibration log |
| | HWIL Test | Requirements must be validated with the following validation |
| | | type: |
| | | HWIL test data log |
| | Ground Test | Requirements must be validated with the following validation |
| | | types: |
| | | Proof that the steps are part of the appropriate checklist |
| | | Configuration file of Horizon Checklist |
| | | Flight test data log |
| | | Standard telemetry log |
| | | User telemetry log |
| | | Vibration lo2 |
| | Simulation Test | Requirements must be validated with the following validation |
| | | types: |
| | | sWIL simulation log |
| | | qHWIL test data log |
| | | HWIL test data log |
| | | VRS file configuration |
| | | Horizon file setting |
| | Inspection | Requirements must be validated with the following validation |
| | | types: |
| | | Proof that the steps are part of the appropriate training |
| | | Proof that the steps are part of the appropriate maintenance |
| | Not Required | Requirements must be validated with the following: |
| | | Not validated at this time |
| | | Not worth validating |
| | | Unable to validate |
| | Other | Requirements must be validated with the following validation |
| | | types: |
| | | Written argument |
| | | Manual/document |
| | | Result of MP Plugin |
| | | Result of Horizon Plugin |
| Before First | No Action | Requirement does not need to be fulfilled or validated before first |
| Flight | | flight |
| | Fulfilled | Requirement must be fulfilled before first flight |
| | Validated by Ground | Requirement must be validated by one or more of the ground tests |
| | Testing | listed below before first flight: |
| | | Proof that the steps are part of the appropriate checklist |
| | | Configuration file of Horizon Checklist |
| | | Flight test data log |
| | | Standard telemetry log |
| | Validated by Simulation | Requirement must be validated by one or more of the simulation |
| | Testing | tests listed below before first flight: |
| | | sWIL simulation log |
| | | qHWIL test data log |
| | | HWIL test data log |
| | | VRS file configuration |
| | Validated by | Requirement must be validated by one or more of the simulation |
| | Simulation/Ground Testing | ground tests listed above before first flight |
| Expires | Never | Requirement never expires |
| | After Configuration | Requirement expires when UAV is progressed to Validation |
| | Complete | Phase |
| | After Validation Complete | Requirement expires when UAV is progressed to Production |
| | | Phase |
| | Manually | Requirement is expired manually |

Options can be entered using drop-down menus, can be user-defined and can be set in the System Settings.

In some embodiments, a requirement can be linked to a bug tracking system or project management system. In some embodiments, this is implemented using a Ticket Number feature. On a user interface, users can enter this ticket number and if the number has been configured in Settings\System Settings of the Requirement module, then selecting the text control will bring the user to the tracking system interface.

In some embodiments, each requirement has a version number, which automatically increments by one each time the requirement is saved with any changes. In the Requirements module, users can revert to a previous version of the requirement, undoing any changes made.

Linking Requirements: In some embodiments, requirements can also be linked together. In some embodiments, a Requirement Links window can be displayed, which shows the name and description of a selected requirement, as well as its current linkages (these are any requirements already linked to the selected requirement). Links can also be removed.

In some embodiments, the list of unlinked requirements can be filtered using one two options. Option 1: Enter text to search for into the Search text box above. Then press Enter. Option 2: Click on the magnifying glass at the left of the Search text box. A list of available fields will display. Select a field to be searched. By default, all of the fields are ticked whenever the Requirements Links window is opened. Click on a field with a tick to remove the field from searches.

Fulfillments: A fulfillment is the process of carrying out or satisfying a requirement. Each UAV requirement requires a fulfillment and a validation to confirm that all of the fulfillment components have been completed.

The following are two examples of the fulfillment process:

1. A “Have the servo serviced every ten flights” requirement might be fulfilled with a maintenance procedure. A user submits the maintenance procedure to configuration system by uploading a maintenance report file.

2. A “Two days of flight time” requirement might be fulfilled with an operational limit in the product manual. In this case, the UAV manufacturer guarantees the UAV has a flight time of two days at this limit. Or, the requirement might be fulfilled with a written argument stating the UAV has been modified to support a flight time of two days.

In many of the fulfillment types available, file name and location are stored in the database, or attached to the fulfillment.

Examples of fulfillment types are show in the following table:

| Fulfillment Types | Description |
|---|---|
| Written argument | Details of the argument are typed into the fulfillment |
| Maintenance procedure | A file (e.g., a Word document or Excel sheet) |
| | documenting the maintenance procedure is attached |
| | to the fulfillment |
| VRS file configuration | Stores a list of autopilot fields and values as they are |
| | required by the fulfillment |
| Engineering calculations | A file (e.g., a Word document or Excel sheet) documenting |
| | the |
| | engineering calculations is attached to the fulfillment |
| Critical action checklist | Users attach a checklist from the MP Horizon Checklist |
| | Plugin |
| Operator training procedure | A file documenting the training procedure is attached to the |
| | fulfillment; |
| Section in a document | This option allows users to attach the file to the fulfillment |
| | and type the name of the section that applies |
| Written critical action | A file documenting the checklist is attached to the |
| checklist | fulfillment |
| Customer-designed MP | This option allows customer to submit source code or |
| Plugin | autopilot BIN |
| Customer-designed | This option allows customer to submit settings from |
| Horizon | Horizon Plugins to fulfill requirements |
| Plugin | |
| Operational limit described | The product manual (e.g., a Word document, Excel sheet, |
| in the product manual | or PDF) is attached to the fulfillment |
| Fly file component | A section of an attached fly file |
| Source code component | The source code file is attached to the fulfillment (Note: |
| | These files must be “*.c” or“* .cpp” files) |
| Requirement cannot be | Requirement cannot be satisfied |
| satisfied | |
| Requirement unimportant | Requirement is not important |

Fulfilling Requirements with Checklists:

Checklists can be used as a means to fulfill requirements in the configuration system. In some embodiments, checklists are added from a plugin, which can be started manually.

Fulfilling Requirements with VRS File Configurations:

A requirement can be met by setting one or more VRS settings to specific value(s). One embodiment of the configuration system keeps track of these settings using the VRS file configuration fulfillment method. A list of VRS fields and values required to meet a fulfillment can be added by a user using a window-based user interface.

Fulfilling Requirements from Sensor Monitor Plugin

Validations:

Validation is the process of checking whether fulfillments for a requirement have been carried out, are correct, and valid.

The following are examples of the validation process:
1. The requirement, “Have the servo serviced every ten flights”, might be fulfilled with a maintenance procedure and then validated by attaching proof that service steps are part of the appropriate maintenance. Documentation supporting this step is stored in the database.
2. The requirement, “Flight time of two days,” might be fulfilled by longer-flight modifications and then validated by the flight test data log.

Some requirements are validated by software simulation. For example, a requirement that in case UAV loses control, it should be able to regain control automatically (tumble recovery). Such a requirement may be too difficult or too dangerous to test in real life. A simulation log or HWIL test data log might be supplied to validate this fulfillment.

Simulations can also be used to validate requirements that are not important enough to justify a flight test for, or that are too difficult to flight test.

The following table provides examples of validation types from one embodiment of the configuration system:

| Validation Type | Description |
|---|---|
| sWIL simulation log | Stores a copy of software in loop simulation log |
| qHWIL test data log | Stores a copy of quasi hardware in loop simulation log |
| HWIL test data log | Stores a copy of true hardware in loop simulation log |
| Written argument | Stores a copy of a user-selected file that documents the written |
| Proof that the steps are part | Stores a copy of a user-selected file that documents the checklist |
| of | steps |
| Proof that the steps are part | Stores a copy of a user-selected file that documents the training |
| of | required or |
| Proof that the steps are part | Stores a copy of a user-selected file that documents the |
| of | maintenance |
| VRS file configuration | Stores a copy of a VRS file |
| Horizon file setting | Stores a copy of a user-selected file that documents the Horizon |
| | settings |
| Manual/document | Stores a copy of a user-selected file |
| Result of MP Plugin | Stores a copy of a user-selected file that shows the required result |
| | of the MP |
| Result of Horizon Plugin | Stores a copy of a user-selected file that shows the required |
| | result of the |
| Configuration file of Horizon | Stores a copy of a user-selected file that shows the required |
| Checklist | result of the |
| Standard Telemetry log | Stores a copy of a Standard Telemetry log file |
| User Telemetry log | Stores a copy of a User Telemetry log file |
| Vibration log | Stores a copy of a Vibration log file |
| Not validated at this time | Requirement is not validated at this time |
| Not worth validating | Requirement is not worth validating |
| Unable to validate | Requirement cannot be validated |

Validating Requirements with Data Logs:

In some embodiments, from a data log viewer, users can submit a data log as validation that a requirement has been meet. The data log can be associated with a simulation, HWIL, or real flight. This can be done using a windows-based user interface.

Validating Requirements with Vibration Logs:

In some embodiments vibration logs from a vibration analyzer, such as the MicroPilot vibration analyzer, can be used to validate requirements in the same way as data logs. The vibration log can be submitted using a windows-based user interface.

Risk Matrix:

Some embodiments of the configuration system include a risk matrix module. Users can place different severity levels on the failure of a mission. For example, one user might decide it acceptable for a mission to fail, providing the UAV can be recovered. On the other hand, another user might decide a mission failure should be avoided at all costs. The configuration system allows users to place a score on the severity and probability of each failure.

Severity and probability values can be monitored by displaying risk matrix tables on a user interface. The matrix can show the number of failure modes by severity and probability. An original score can be calculated as the sum of the probability score multiplied by the severity score for each failure mode. When requirements linked to failure modes are fulfilled, the severity level reduces. When these requirements have been validated, the probability reduces. A Current Score, based on fulfilled and validated requirements, can be updated as changes are made to the UAV.

Flight Tests/Flight Test Cards:

Some requirements will require flight testing for their fulfillments or validations. In an embodiment of the configuration system, each requirement requiring testing has a flight test, such as an electronic flight test card, created against it. Many flight tests can be added to a Flight Test Card and then assigned to one or more users who then perform testing. Grouping flight tests by testing session onto one Flight Test Card can reduce flight testing expenses.

The first step is to create the flight tests. Then the flight test card is created. Then one or more flight tests and one or more users can be assigned to the flight test card. The users assigned to a flight test card are the users who will be performing the tests.

Once a flight is completed and the data log is downloaded, the data log can be attached to all of the successfully tested requirements.

Project Phases:

One embodiment of the configuration system has four development phases: Design; Configuration; Validation; and Production. A new UAV project begins in the Design Phase. Once all requirements are entered, the project enters the Configuration Phase. Progressing from Design Phase to Configuration Phase, the UAV must have at least one requirement before it can be progressed to the Configuration Phase. Progressing from Configuration Phase to Validation Phase requires all of the UAV's requirements to be fulfilled. A sub-phase of the Validation Phase is preparing for the first test flight. To reduce risk during this phase, an embodiment of the configuration system allows requirements to require validation prior to first flight. Progressing from Validation Phase to Production Phase requires the UAV to have all of its requirements validated.

Editing a requirement property, fulfillment, or validation can be done at different phases, as long as a user has the privileges to edit a requirement. This will cause the requirement, its validations, and its fulfillments, to go into a review state. The user must then review the fulfillments and validations and accept the changes to allow the requirement to go back to the non-review state.

Project Progress:

An embodiment of the configuration system gives users a quick glimpse of a project's status via the Project Progress display. Examples of progress that can be displayed include: All Requirements, High-Level Requirements, and Low-Level Requirements. Indications can be shown of how far along the requirements have been fulfilled and validated. The ratio and percentage can also be displayed. It is also possible to show the percentage of requirements fulfilled and/or validated as set for each requirement, prior to the commencement of the first test flight.

Although the present application discloses example methods and apparatus including, among other components, software executed on hardware, such methods and apparatus are merely illustrative and should not be considered as limiting. For example, any or all of these hardware and software components could be embodied exclusively in hardware, exclusively in software, exclusively in firmware, or in any combination of hardware, software, and/or firmware. Accordingly, while example methods and apparatus are described herein, persons having ordinary skill in the art will appreciate that the examples provided are not the only ways to implement such methods and apparatus.

Furthermore, the present technology can take the form of a computer program product comprising program modules accessible from computer-usable or computer-readable medium storing program code for use by or in connection with one or more computers, processors, or instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium (though propagation mediums in and of themselves as signal carriers are not included in the definition of physical computer-readable medium). Examples of a physical computer-readable medium include a semiconductor or solid state memory, removable memory connected via USB, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), DVD, and Blu-Ray™. Processors and program code for implementing aspects of the technology described herein can be centralized or distributed (or a combination thereof).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations. Furthermore, to the extent that the term “includes” is used in either the detailed description or the claims, such term is intended to be inclusive in a manner similar to the term “comprising” as “comprising” is interpreted when employed as a transitional word in a claim.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

1. An electronic flight test card for testing a UAV (Unmanned Aerial Vehicle) design, the flight test card comprising:
a module comprising a list of tests to be performed, each test linked to a requirement for a system or subsystem of the UAV;
an interface for communicating with the UAV;
a storage medium with a data log for storing the test results received through the interface;
a display module for displaying test information; and
an output for exporting the data log to a configuration system.

2. The electronic flight test card of claim 1, further comprising: a user interface module for receiving comments and wherein, the storage medium also stores the comments.

3. The electronic flight test card of claim 1, further comprising ground station interface for communicating with a mobile ground station.

4. The electronic flight test card of claim 1, wherein the storage medium has a description of each test stored thereon and the description is accessible for display on the display module.

5. The electronic flight test card of claim 1, wherein the storage medium has a schedule data stored thereon and the schedule data is accessible for display on the display module.

6. The electronic flight test card of claim 1 configured to be stored on a ground control station.

7. The electronic flight test card of claim 1, configured to communicate with an autopilot module of the UAV through the interface for communicating with the UAV.

8. The electronic flight test card of claim 7 configured to provide the autopilot with the list of tests to be performed.

9. The electronic flight test card of claim 7 configured to receive, from the autopilot, test identification information indicating whether each test passed or failed.

10. The electronic flight test card of claim 9, wherein the test identification information incorporated into the data log.

11. The electronic flight test card of claim 1, further comprising an indication of a start time for each test.

12. The electronic flight test card of claim 11, further comprising an indication of an end time for each test.

13. A non-transitory computer readable medium having computer readable instructions stored thereon for implementation by a processor, the instructions comprising:
creating a module comprising a list of tests to be performed, each test linked to a requirement for a system or subsystem of the UAV;
communicating with the UAV through an interface;
storing test results received through the interface in a data log;
displaying test items on a display module; and
exporting the data log to a configuration system.

14. A computer-implemented method of creating an electronic flight test card to validate UAV (Unmanned Aerial Vehicle) design requirements, the method comprising:
creating the electronic flight test card based on requirements of systems and subsystems of the UAV
assigning at least one flight test and at least one user to the electronic flight test card;
downloading the electronic test card to a mobile ground control station;
recording test data in a data log on the electronic flight test card while conducting the at least one flight test; and
uploading the data log from the electronic test card to a configuration system after the at least one flight test is complete.

15. The method of claim 14, further comprising:
analysing the data log to determine if further changes to the design requirements are required; and
outputting results of the analysing to an output of the configuration system.

16. The method of claim 14 further comprising recording a start time for each test.

17. The method of claim 16 further comprising recording an end time for each test.

18. The method of claim 14 further comprising recording a start time and an end time for each test and using the start time and the end time to link a portion of the data log to one or more of the requirements.
